(19) United States
(12) Patent Application Publication
(10) Pub. No.: US 2012/0137179 A1
(43) Pub. Date: May 31, 2012

(54) PROCESSING SYSTEM FOR MONITORING POWER-ON SELF-TEST INFORMATION

(75) Inventors: Chih-Jen Chin, Taipei (TW); Xue-Shan Han, Tianjin (CN); Ya-Jing Fan, Tianjin (CN); Chih-Feng Chen, Taipei (TW)

(73) Assignee: INVENTEC CORPORATION, Taipei (TW)

(21) Appl. No.: 13/070,901

(22) Filed: Mar. 24, 2011

(30) Foreign Application Priority Data
Nov. 30, 2010 (CN) 201010589569.8

(51) Int. Cl. G06F 11/22

(52) U.S. Cl. 714/36; 714/E11.149

(57) ABSTRACT

A processing system for monitoring the power-on self-test information is used for monitoring an operating state of a complex programmable logic device (CPLD) of a main board. The processing system includes a basic input/output system (BIOS) device, a CPLD and a monitoring device. The BIOS device sends power-on self-test information at a first frequency. The CPLD is electrically connected to the BIOS device. The CPLD further includes a first in first out (FIFO) register, and the FIFO register is used for storing the received power-on self-test information. The CPLD sends the power-on self-test information stored in the FIFO register at a second frequency. The monitoring device is electrically connected to the CPLD. The monitoring device is used for receiving the power-on self-test information sent from the CPLD.

### CROSS-REFERENCE TO RELATED APPLICATIONS

This non-provisional application claims priority under 35 U.S.C. §119(a) on Patent Application No(s). 201010589569.8 filed in China, P.R.C. on Nov. 30, 2010, the entire contents of which are hereby incorporated by reference.

### BACKGROUND OF THE INVENTION

1. Field of the Invention

The present invention relates to a monitoring system, and more particularly to a processing system for monitoring power-on self-test information.

2. Related Art

In the prior art, a baseboard management control device is used to detect operation of a main board. Generally, to achieve normal operation of a main board, a power supply device needs to normally supply power to the main board. If the power supplied by the power supply device is not stable, peripheral devices in the main board may be damaged.

In a main board 100 in the prior art, a complex programmable logic device (CPLD) 110 is disposed. The CPLD 110 is mainly used for controlling sending of reset signals of peripheral devices 120 such as power on/off and fan detection. However, the CPLD 110 in the prior art uses a plurality of light emitting diodes (LEDs) 130 for displaying the above signals, but the LEDs 130 can display only one set of power-on self-test information each time. Therefore, the LEDs 130 changes the display state thereof immediately after receiving new power-on self-test information. Since the LEDs 130 change rapidly under the rapid operation of a basic input/output system (BIOS), the user cannot observe whether an anomaly occurs in the process of sending the signals. FIG. 1 is a schematic architectural view of a hardware test in the prior art.

After an anomaly occurs, the manufacturer cannot know which peripheral device 120 has an error. As for the prior art, the peripheral devices have to be detected one by one through an oscilloscope or other apparatuses. Such a process can only be implemented manually, and therefore, the time and labor taken for detecting an abnormal device is a heavy burden for the manufacturer.

### SUMMARY OF THE INVENTION

Accordingly, the present invention is a processing system for monitoring power-on self-test information, which is for monitoring an operating state of a CPLD of a main board.

The power-on self-test information for monitoring the power-on self-test information of the present invention comprises a BIOS device, a CPLD and a monitoring device. The BIOS device sends power-on self-test information at a first frequency. The CPLD is electrically connected to the BIOS device. The CPLD further comprises a first in first out (FIFO) register, and the FIFO register is used for storing the received power-on self-test information. The CPLD sends the power-on self-test information stored in the FIFO register at a second frequency. The monitoring device is electrically connected to the CPLD. The monitoring device is used for receiving the power-on self-test information sent from the CPLD.

The monitoring device of the power-on self-test information of the present invention enables a complete presentation of the power-on self-test information through buffering by the CPLD. Moreover, since the monitoring device is disposed on the main board in the present invention, the state display manner using the LEDs 130 as in the prior art is not required. As such, not only the cost of jigs can be effectively reduced, but also the operation process of the power-on self-test information can be completely presented.

### BRIEF DESCRIPTION OF THE DRAWINGS

The present invention will become more fully understood from the detailed description given herein below for illustration only, and thus are not limitative of the present invention, and wherein:

FIG. 1 is a schematic architectural view of a hardware test in the prior art;

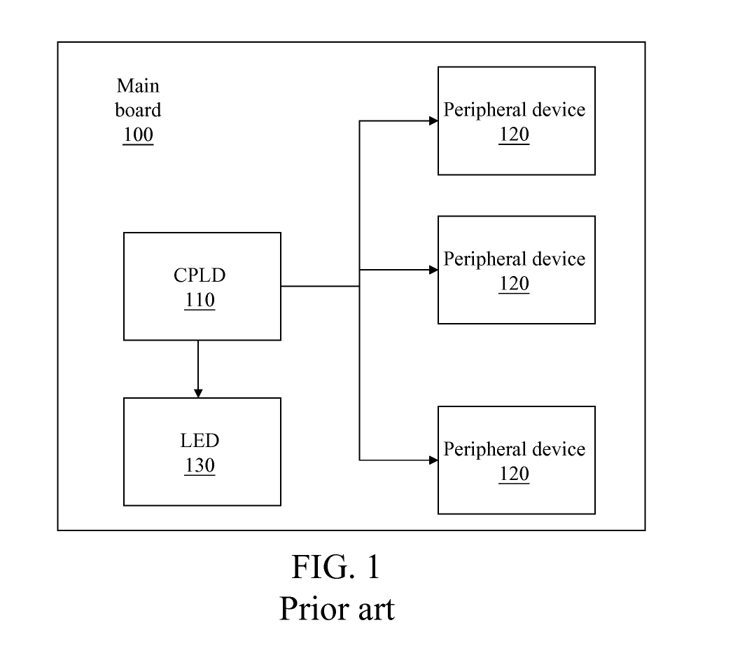

FIG. 2 is a schematic architectural view of the present invention; and

FIG. 3 is a schematic view of an embodiment of different protocol conversion devices of the present invention.

### DETAILED DESCRIPTION OF THE INVENTION

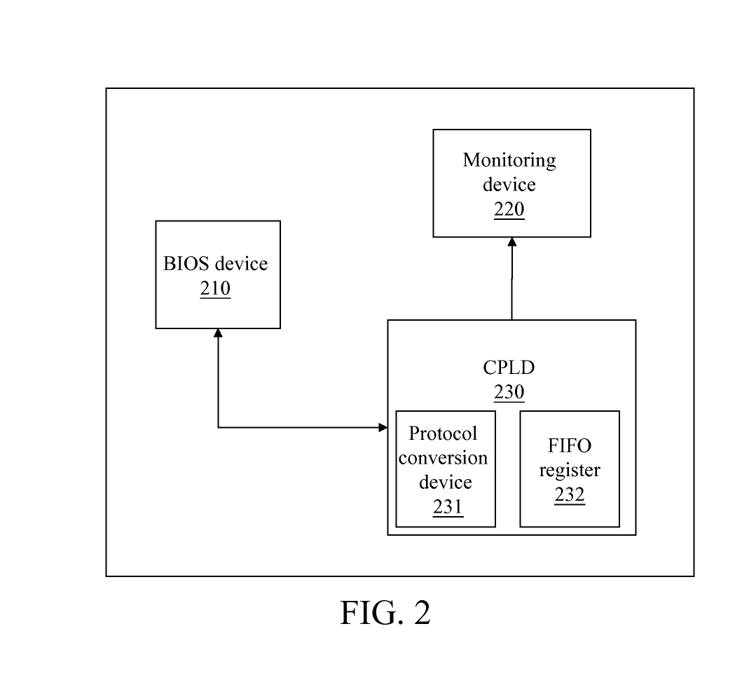

The present invention is applied to a main board of a computer apparatus, and used for monitoring operating information of the main board in a power-on self-test process. FIG. 2 is a schematic architectural view of the present invention. The monitoring system of the present invention comprises a BIOS device 210, a monitoring device 220 and a CPLD 230. The BIOS device 210 sends power-on self-test (POST) information at a first frequency. The CPLD 230 is electrically connected to the BIOS device 210.

The BIOS device 210 is used for boot processing of the main board. In the boot process of the main board, peripheral devices connected to the main board and connection states thereof need to be tested through a power-on self-test procedure. The peripheral devices are a south bridge chipset, a north bridge chipset or a personal computer interface express (PCI-E). The BIOS device 210 may be connected to the CPLD 230 through a serial general purpose input/output (SGPIO) pin or a low pin count bus.

The CPLD 230 further comprises a protocol conversion device 231 and an FIFO register 232. The FIFO register 232 is used for storing the received power-on self-test information. In the present invention, the capacity of the FIFO register 232 is not limited. Generally, the power-on self-test information output from the BIOS device 210 is 8 bits, so the capacity of the FIFO register 232 may be set to 1 Kbits. As described above, the BIOS device 210 continuously outputs the power-on self-test information at the first frequency in the boot process. To prevent the monitoring device 220 from reflecting the power-on self-test information in real time, the power-on self-test information is temporarily stored in the FIFO register 232. Table 1 is a list of the power-on self-test information.

TABLE 1
List of power-on self-test information

| Power-on | |
|---|---|
| self-test | |
| code (Hex) | Description of operational objectives |
| 3 | Initialize Chips: Disable NMI, PIE, AIE, UEI, SQWV. |
| | Disable video, parity checking, DMA. Reset math |
| | coprocessor. Clear all page registers, CMOS shutdown |
| | byte. Initialize timer 0, 1, and 2, including set |
| | EISA timer to a known state. Initialize DMA |
| | controllers 0 and 1. Initialize interrupt controllers |
| | 0 and 1. Initialize EISA extended registers. |
| 4 | Test Memory Refresh Toggle: RAM must be periodically |
| | refreshed to keep the memory from decaying. This |
| | function ensures that the memory refresh function is |
| | working properly. |
| 5 | Initialize keyboard: keyboard controller initialization. |
| 6 | Reserved |
| 7 | Test CMOS Interface and Battery Status: Verifies CMOS |
| | is working correctly, detects bad battery. BE—Chipset |
| | Default Initialization: Program chipset registers with |
| | power on BIOS defaults. |
| C1 | Memory presence test: OEM specific—Test to size |
| | on-board memory. |
| C5 | Early Shadow: OEM specific—Early Shadow enable |
| | for fast boot. |
| C6 | Cache presence test: External cache size detection |
| 8 | Setup low memory: Early chip set initialization. Memory |
| | presence test. OEM chip set routines. Clear low 64k of |
| | memory. Test first 64k memory. |

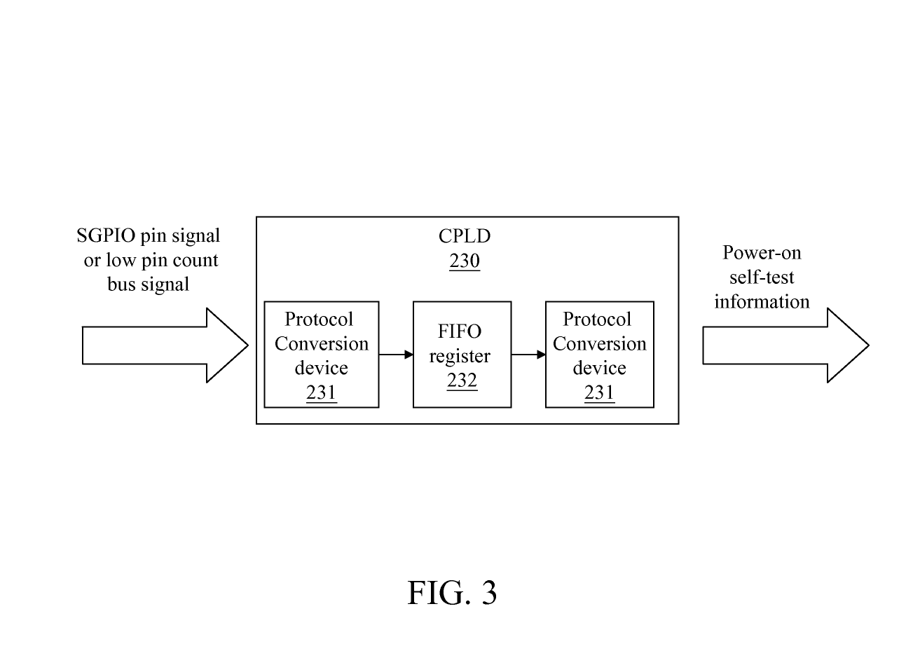

The protocol conversion device 231 converts the received power-on self-test information into an information format conforming to the CPLD 230, or converts an information format of the CPLD 230 into an information format readable by the monitoring device 220. Different numbers of protocol conversion devices 231 may be disposed according to different embodiments. For example, a protocol conversion device 231 is disposed between the CPLD 230 and the BIOS device 210, and another protocol conversion device 231 is disposed between the CPLD 230 and the monitoring device 220, as shown in FIG. 3. Definitely, the input/output conversion may also be implemented through the same protocol conversion device 231.

Generally, the CPLD 230 may receive or send the power-on self-test information through a port 80. In case of other special requirements in implementation, the transfer or receiving process may also be performed through other ports. For example, the CPLD 230 may receive the power-on self-test information through a port 80, and transfer the power-on self-test information through a port 60. The CPLD 230 sends the power-on self-test information stored in the FIFO register 232 at a second frequency. As described above, to enable the user to observe the operation process of the power-on self-test information, the CPLD 230 sends the power-on self-test information to the monitoring device 220 at a second frequency smaller than the first frequency.

The monitoring device 220 may be connected to the CPLD 230 through an existing output interface of the main board. The monitoring device 220 may be electrically connected to the CPLD 230 through a serial peripheral interface (SPI) bus.

The monitoring device 220 is used for displaying an operating state of the power-on self-test information. The monitoring device 220 may be electrically connected to another computer apparatus. The monitoring device 220 may be connected to a personal computer through an RS-232, a universal serial bus (USB) or an Ethernet. The monitoring device 220 transfers the power-on self-test information to the computer apparatus through the above connection manner. A tester may observe the power-on self-test information sent from the monitoring device 220 through the personal computer, so that the tester can know whether the main board has an ignored hardware error in the boot process, and further find the error.

The monitoring device 220 of the power-on self-test information of the present invention enables a complete presentation of the power-on self-test information through buffering by the CPLD 230. Moreover, since the monitoring device 220 is disposed on the main board in the present invention, the state display manner using the LEDs as in the prior art is not required. As such, not only the cost of jigs can be effectively reduced, but also the operation process of the power-on self-test information can be completely presented.

What is claimed is:

1. A processing system for monitoring the power-on self-test information, for monitoring an operating state of a complex programmable logic device (CPLD) of a main board, the processing system comprising:
a basic input/output system (BIOS) device, for sending power-on self-test information at a first frequency;
a CPLD, electrically connected to the BIOS device, wherein the CPLD further comprises a first in first out (FIFO) register, the FIFO register is used for storing the received power-on self-test information, and the CPLD sends the power-on self-test information stored in the FIFO register at a second frequency; and
a monitoring device, electrically connected to the CPLD, wherein the monitoring device is used for receiving the power-on self-test information sent from the CPLD.

2. The processing system for monitoring the power-on self-test information according to claim 1, wherein the CPLD further comprises a protocol conversion device, for converting the received power-on self-test information into an information format conforming to the CPLD, or for converting an information format of the CPLD into an information format readable by the monitoring device.

3. The processing system for monitoring the power-on self-test information according to claim 1, wherein the CPLD adds boot information of a plurality of peripheral devices of the main board into the power-on self-test information.

4. The processing system for monitoring the power-on self-test information according to claim 3, wherein the peripheral devices are a south bridge chipset, a north bridge chipset or a personal computer interface express (PCI-E).

5. The processing system for monitoring the power-on self-test information according to claim 1, wherein the BIOS device is connected to the CPLD through a serial general purpose input/output (SGPIO) pin or a low pin count bus.

6. The processing system for monitoring the power-on self-test information according to claim 1, wherein the monitoring device is electrically connected to a computer apparatus, and transfers the power-on self-test information to the computer apparatus.
